(19) United States
(12) Patent Application Publication
(10) Pub. No.: US 2014/0272485 A1
(43) Pub. Date: Sep. 18, 2014

(54) Flow Batteries with Modular Arrangements of Cells

(71) Applicant: EnerVault Corporation, Sunnyvale, CA (US)

(72) Inventors: Jay E SHA, Mountain View, CA (US); Bruce LIN, Mountain View, CA (US)

(73) Assignee: EnerVault Corporation, Sunnyvale, CA (US)

(21) Appl. No.: 14/215,534

(22) Filed: Mar. 17, 2014

Related U.S. Application Data
(60) Provisional application No. 61/794,999, filed on Mar. 15, 2013.

(51) Int. Cl. H01M 8/20

(52) U.S. Cl. CPC H01M 8/20
USPC 429/51; 429/105

(57) ABSTRACT

A modular arrangement of cells that enables adjustments in cell currents in response to changes in concentration of the redox reactants. The adjustments improve battery efficiency by more closely matching the current in a given cell to the rate at which reactants are supplied to that cell. The cell modules provide the flexibility to operate flow batteries efficiently over a wide range of electrolyte states of charge and allow managed scale-up while easing manufacturability concerns.

### CROSS-REFERENCE TO RELATED APPLICATIONS

This application claims the benefit of U.S. Provisional Patent Application Ser. No. 61/794,999, filed Mar. 15, 2013 and entitled, “Flow Batteries with Modular Arrangements of Cells,” the contents of which are incorporated herein by reference in their entirety

### STATEMENT OF FEDERALLY FUNDED RESEARCH

Inventions included in this patent application were made with Government support under DE-OE0000225 “Recovery Act—Flow Battery Solution for Smart Grid Renewable Energy Applications” awarded by the US Department of Energy (DOE). The Government has certain rights in these inventions.

### FIELD

This invention generally relates to reduction/oxidation (redox) flow batteries and more particularly to redox flow batteries incorporating modular blocks of cells.

### BACKGROUND ART

Advances in electrical energy technology are frequently impeded by a lack of appropriate means for electrical energy storage (EES). For example, renewable energy sources such as wind and solar could meet a significant proportion of the world's electricity needs. Yet these sources remain largely untapped for want of viable EES capacity. In the same way, large-scale EES will be critical to the success of initiatives to modernize the national electric power grid.

Rechargeable batteries are a proven means for EES, but conventional rechargeable batteries using established battery chemistries are poorly suited for large-scale applications. The poor suitability of conventional rechargeable batteries arises due to energy being stored in the form of solid reactants that form part of the battery electrodes. For this reason, a conventional battery can never achieve more than a small fraction of its theoretical energy density (e.g., in kilowatt-hours per kilogram). Furthermore, the electrodes must undergo physical and chemical changes each time the battery is charged and discharged. These changes impose limits not only on the cycle life, but also on the maximum power (e.g., in kilowatts) that can be delivered.

Redox Flow Batteries (RFBs) are rechargeable systems in which the electrochemical reactants are dissolved in liquid electrolytes. The electrolytes, which are stored in external tanks, are pumped through a stack of reaction cells where electrical energy is alternately converted to and extracted from chemical energy in the reactants by way of reduction and oxidation reactions.

In the simplest form of an RFB, the stack comprises a single block of cells electrically connected in series and through which electrolytes are circulated repeatedly. During discharge, the state of charge (SOC) of the electrolytes and thus the battery is progressively lowered during each pass through the stack.

### SUMMARY OF THE INVENTION

In a cascade RFB, the stack may be divided into several “stages”, with all cells of all stages electrically connected in series. As the electrolytes flow sequentially through each stage of the cascade during discharge, the SOC is progressively lowered in each stage, generally accomplishing complete discharge in a single pass through the cascade stack. In embodiments, “complete” discharge or charge for a given system may involve less than 100% of the possible state-of-charge (SOC). For example, an RFB system may be “completely discharged” when it is at 10% SOC, and may be “completely charged” when it is at 90% SOC.

As with conventional batteries, the power produced by an RFB is determined by the size of the battery stack. However, unlike conventional batteries, the energy storage capacity of an RFB is limited only by the volume of the external storage components.

The power output of a battery is the product of the current and voltage that it delivers (Watts=Volts×Amps). For a given battery chemistry, the current output depends on the electrode area of the individual battery cells. Because of practical considerations that restrict the maximum size of the cells, there is an upper limit to the power that can be delivered by some RFB designs.

In the past, manufacturability considerations have imposed finite limits on the physical dimensions of a cell. RFB architecture has also been constrained by the need to balance efficiency and safety considerations through appropriate choices of stage count, cell count, separator type and other factors.

According to embodiments of the systems and methods herein, cells within an RFB may be grouped into modules that may be arranged in ways that allow the RFB to operate safely over a wide range of SOC while maintaining high round trip energy efficiency, while minimizing material degradation.

According to additional embodiments of the systems and methods herein, cells within an RFB may be grouped into modules that may be arranged in ways that raise output power while avoiding the costs normally associated with increasing the physical size of RFB cells.

### BRIEF DESCRIPTION OF THE DRAWINGS

The novel features of the invention are set forth with particularity in the claims that follow. A better understanding of the features and advantages of the systems and methods herein will be obtained by reference to the following detailed description that sets forth illustrative embodiments, in which the principles of the invention are utilized, and the accompanying drawings of which:

FIG. 1 is a schematic diagram illustrating features of a recirculating redox flow battery (RFB) suitable for use in embodiments.

FIG. 2A is a diagram illustrating a cell in a recirculating RFB suitable for use in embodiments.

FIG. 2B is a diagram illustrating a group of cells in a recirculating RFB suitable for use in embodiments

FIG. 2C is a schematic diagram illustrating components of a recirculating RFB suitable for use in embodiments.

FIG. 3 is a schematic diagram illustrating a stage of a cascade RFB suitable for use in embodiments.

FIG. 4 is a schematic diagram illustrating electrolyte flow paths through multiple stages of a cell stack of a cascade RFB suitable for use in embodiments.

FIG. 5 is a diagram illustrating modular cell blocks connected both electrically and fluidically in parallel suitable for use in embodiments.

FIG. 6 is a diagram illustrating an arrangement of cells in an exemplary five stage cascade RFB stack suitable for use in embodiments.

FIG. 7 is a graph illustrating relationships between mean electrolyte state-of-charge (SOC), relative electric current per cell, and relative stoich in a multi-stage cascade RFB, such as that illustrated in FIG. 6.

FIG. 8 is a diagram illustrating a modular cascade arrangement having modules connected in various series/parallel combinations suitable for use in embodiments.

FIG. 9 is a graph illustrating relationships between mean electrolyte state-of-charge (SOC), electric current per cell, and relative stoich in a modular cascade arrangement, such as that of FIG. 8.

FIG. 10A-10E are schematic diagrams illustrating various configurations for groups of cell modules and switches for various parallel and series electrical connections suitable for use in embodiments.

FIG. 11 is a graph illustrating relationships between mean SOC, current per cell, and relative stoich in a flow battery configuration having groups of cell modules and switches, such as that of FIG. 10A.

### DETAILED DESCRIPTION

A modular arrangement of cells is disclosed that improves battery efficiency by enabling adjustments to cell currents in response to changes in the concentration of battery reactants. The adjustments more closely match the current in a given cell to the rate at which reactants are supplied to that cell. Grouping battery cells into modules provide a means to operate flow batteries efficiently over a wide range of electrolyte states of charge and to extend the limits of battery scale-up.

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

### DEFINITIONS

Certain terms that are used throughout the application are explained here. Other terms that appear less frequently are explained as they arise.

As used herein, the terms “about” or “approximately” for any numerical values or ranges may indicate a suitable temperature or dimensional tolerance that allows the part or collection of components to function for its intended purpose as described herein.

The term “engineered cascade RFB” may be used herein to refer generally to a cascade RFB in which cells, stages and/or arrays within the battery are configured in terms of materials, shapes and sizes, reactant flow, and/or other variables based on an expected condition of reactants (e.g., a range of electrolyte SOC to be experienced by the cells) so as to increase the battery's performance (e.g., round trip energy efficiency, power output, reduced electrolyte breakdown, reduced hydrogen generation, improved safety, decreased material degradation, or other performance metric) over that achievable in a cascade RFB in which all cells, stages and/or arrays along the reactant flow path are substantially the same as one another.

As used herein, the terms “optimized,” “optimum” and similar variants may indicate parameters which may be controlled or varied in a cascade RFB in order to improve performance and to distinguish from arrangements in which there is no configuration or control based on expected local properties of reactants. Use of these terms may not require that any cells, stages and/or arrays or components thereof are necessarily configured for the best possible or theoretical performance.

Unless otherwise specified, the terms anolyte and catholyte are used herein as if the battery were always in a discharge mode. Hence, the term “anolyte” will refer to the electrolyte in contact with the negative electrode of an electrochemical reaction cell and the term “catholyte” will refer to the electrolyte in contact with the positive electrode of an electrochemical reaction cell.

As used herein, the phrase “state of charge” and its abbreviation “SOC” refer to the instantaneous ratio of useable to theoretical stored electrical charge (measured in ampere-hours). The terms may be applied either to the charge storage capacity of a complete RFB system or to electrolytes within a particular component of the RFB. “Useable” charge may refer to stored charge that may be delivered at or above a threshold voltage (e.g. about 0.7 V in embodiments of Fe/Cr RFB systems).

The energy produced or consumed by an electrochemical cell can be expressed as the product of cell voltage, current and time (Joules=Volts×Amps×Seconds). Energy losses within the cell can arise from two distinct effects, known as “Voltage efficiency” and “Faradaic efficiency”.

Voltage efficiency falls below 100% when the measured cell voltage deviates from the theoretical potential difference (the so called “thermodynamic reversible potential”) for that cell. The magnitude of the voltage deviation is known as the cell “overpotential” and in general the overpotential includes contributions from energy losses at each electrode. The overpotential at the cell anode (i.e., the electrode at which oxidation is occurring) has a positive sign, while the overpotential at the cell cathode (i.e., the electrode at which reduction is occurring) has a negative sign. Hence, on charge, the two overpotentials combine to increase the cell voltage (wasting some of the input energy) and on discharge, they combine to decrease the cell voltage (wasting some of the output energy).

As used herein, the term “Faradaic efficiency” may refer to the proportion of the electric current flowing at an electrode that achieves the intended oxidation or reduction reaction. A Faradaic efficiency of unity (100%) may mean that none of the current is wasted on parasitic reactions (defined below). In RFBs, Faradaic efficiencies less than 100% can arise from an inadequate supply (or “flux”) of redox reagent to the electrode surface or imperfect selectivity for the preferred reaction.

As used herein, the terms “stoich” and “stoich flow” refer to the ratio of the flux of a redox reactant entering an electrochemical cell (or cell module) to the rate at which the reactant is consumed in the cell (or cell module). The reactant flux depends on both the concentration of the reactants in the electrolytes and the flow rate of the electrolytes into the cell. The rate at which reactants are consumed depends on the electric current supplied to the cell (during charging) or drawn from the cell (during discharging), cell voltage, and other factors.

To illustrate the meaning of stoich, one may consider a cell that is being supplied with 10⁻⁴ mole per second of the reactant Fe³⁺, which is being consumed in the reduction reaction of EQ(1):

Fe³⁺+e⁻=Fe²⁺ EQ(1)

A current of 10⁻⁴ moles per second of electrons is 10⁻⁴ Faraday per second (approximately 9.65 amps). Hence an electric current of that magnitude would give a stoich value of 1.0 in the cell, since every mole of the Fe³⁺ supplied to the cell each second would be reduced to Fe²⁺. Similarly, a current of half that magnitude would give a stoich value of 2.0, since the quantity of Fe³⁺ supplied to the cell each second would be twice the quantity reduced to Fe²⁺ during the same second.

Like Faradaic efficiency, stoich is a dimensionless quantity and the term applies to both charging and discharging reactions. For these and other reasons, stoich values substantially greater than 1.0 may be required to prevent significant losses in Faradaic efficiency in a redox flow battery.

When the Faradaic efficiency at one or both electrodes in a cell falls below 100%, the electrode or electrodes can be driven into overpotential ranges where “parasitic” electrode reactions arise to make up the deficit in Faradaic current. For example, in the Fe/Cr RFB, low stoich conditions in the negative electrolyte during charge can drive the electrode potential low enough to initiate hydrogen evolution via the electrode reaction of EQ(2):

2H⁺+2e⁻=H₂ EQ(2)

Similarly, low stoich conditions in the positive electrolyte during charge can drive the electrode potential high enough to initiate chlorine evolution via the electrode reaction of EQ(3):

2Cl⁻=Cl₂+2e⁻ EQ(3)

Parasitic reactions can also arise when low stoich conditions develop during discharge. However, other competing factors may also affect the rate at which parasitic reactions occur. For example, the hydrogen evolution reaction above tends to increase when electrolytes are at higher SOC levels. Optimizing to minimize parasitic reactions may lead to a result that actually decreases stoich under some conditions. Therefore, in some cases, one or more factors may be optimized at the expense of others.

All of the charge consumed in parasitic reactions subtracts directly from the “useable” charge stored by the battery. As used herein, the term “useable” charge may refer to stored charge that may be delivered at or above a threshold voltage (e.g. about 0.7 V in embodiments of the Fe/Cr RFB system).

### RFB Systems and Components

FIG. 1 depicts some basic components of a flow battery system 10. In addition to at least one storage tank 11 for each electrolyte, the battery may include pumps 12 for circulating the electrolytes through a stack of electrochemical cells 14. Charging current may be supplied by a power source 16 and discharge current may be supplied or delivered to a load 18. A controller 19 may be provided for automatically controlling various flow battery operations such as switching between charging and discharging, controlling charging or discharging conditions, controlling pump speeds, controlling switchable electrical connections, or any other controllable operation of the flow battery system. Control may be achieved through a control bus 19a, which may include connections to sensors, actuators, switches or other components necessary for controlling operations as would be appreciated by one of skill in the art. It will also be evident that controller 19 may be computer controlled and may be configured with processor executable instructions that cause the controller, which may be a processor or equipped with a processor, to perform such operations.

FIG. 2A, FIG. 2B and FIG. 2C various aspects of a cell stack in more detail. FIG. 2A depicts a single cell 20, comprising a positive electrode 21, a negative electrode 22, a positive electrolyte chamber 23, a negative electrolyte chamber 24, and a separator 25. FIG. 2B depicts a stack 14 of four such cells 20. FIG. 2C shows the same four cells 20 connected to electrolyte tanks 11 via positive and negative manifolds 27 and 28. The manifolds may distribute positive and negative electrolytes in the directions shown by arrows 26 such that the electrolyte compositions experienced by each cell 20 are identical or substantially identical. The cells 20 may be electrically connected in series and the voltage generated by the series stack may be used to drive electric current through a load 18.

During discharge, the charged forms of the redox reactants undergo reduction and oxidation reactions as the electrolytes contact the electrodes 21 and 22 respectively, generating DC power and progressively lowering the proportion of charged redox reactants in the electrolytes with each fluid pass through the cell stack 14. Re-charging of the battery may be accomplished by supplying electrical energy (e.g., from a solar cells array or any other power source 16) to drive the redox reactions in reverse while the electrolytes continue to circulate through the cell stack 14.

In other RFB architectures, the electrolytes may be fully discharged in a single fluid pass through the cell stack and the spent electrolytes may be collected in separate tanks (for a total of at least four separate tank volumes). An effective implementation of this single pass (or “4-tank”) architecture is an engineered cascade RFB in which cells, stages and/or arrays within the battery are configured to increase the performance of the battery over a performance that may be achievable in a cascade RFB in which all cells, stages and/or arrays along the reactant flow path are substantially the same as one another. For example, within an engineered cascade RFB, each cascade stage may be tailored to a specific SOC range. Various examples of such engineered cascade RFB systems are provided in US Patent Application Publication 2011/0223450, the contents of which are incorporated herein by reference.

FIG. 3 illustrates one stage 30 of a cascade RFB, which in the present example, includes four cells 20 electrically connected in series. The top arrows 32 indicate the parallel flow paths of the positive electrolyte through the cells 20. The bottom arrows 34 indicate the parallel flow path of the negative electrolyte through the cells 20.

FIG. 4 illustrates a cascade RFB 40, which in this example, includes 5 stages 41-45. The details of each stage have been omitted for clarity. The arrows 46 indicate the flow paths of both positive and negative electrolytes. The two electrolytes flow from tanks 47 at the top of the diagram, which may contain charged electrolytes, into the first stage of the cascade 41 and then proceed in sequence through the remaining stages 42-45 until the spent electrolytes are collected in tanks 48 at the bottom of the diagram.

Among the leading factors that degrade round trip energy efficiency in an RFB are the cyclic changes that occur in redox reactant concentrations each time the RFB is charged and discharged. As the electrolyte is charged, the high SOC stages will contain progressively less of the discharged reactant, eventually lowering the Faradaic efficiency to the point where current (and hence energy) is diverted into parasitic electrode reactions. All of the energy diverted into parasitic reactions is lost from the battery output, directly lowering the round-trip energy efficiency.

For example, in the Fe/Cr RFB, charging efficiency declines when most of the Fe²⁺ ions in the positive electrolyte have been oxidized to Fe³⁺ ions and most of the Cr³⁺ ions in the negative electrolyte have been reduced to Cr²⁺ ions. Likewise, discharge efficiency declines when most of the Fe³⁺ ions in the positive electrolyte have been reduced to Fe²⁺ ions and most of the Cr²⁺ ions in the negative electrolyte have been oxidized to Cr³⁺ ions.

The rate of supply (or “flux”) of reactants to a given cell may depend on both the local concentration of reactants in the electrolytes and the local volumetric flow rate of electrolytes through the cell. The rate of reactant consumption may depend on both structural and operating characteristics of the RFB.

Practical flow battery cells may have a minimum operational stoich value greater than unity. For example, in embodiments, depending on the configuration of flow battery components, a minimum allowable stoich may assume a value of 1.3, 1.5 or even 2. A maximum possible stoich value will depend on overall system parameters, such as a total number of cells, a number of cascade stages, an operating range of SOC, operating flow rates, relative electrode chamber volumes and other factors.

In engineered cascade flow battery systems, the cell stack may be divided into a series of stages wherein each stage may comprise an equal number of cells connected electrically in series. In a cascade, cell reactions in each stage progressively change the state-of-charge of electrolytes by a fraction of the total SOC range of the system. The amount of SOC change in a given stage may be directly related to the rate at which reactants are consumed less any losses due to parasitic reactions or other causes. In various embodiments, a cascade may be configured to cause SOC to change by a substantially equal amount in each stage—i.e., linearly—or by varying amounts—e.g., monotonically, non-linear monotonically, or according to any other non-linear function. The change in SOC from inlet to outlet may lead to a corresponding (e.g., linear, monotonic or other) decrease in stoich from the inlet end to the outlet end of the cascade. This decrease in stoich may occur because the electrolytes progressively lose available reactants as they are consumed in each stage of the cascade.

Thus, in an engineered cascade system, the cells and stages at the downstream end of the cascade may encounter a relatively low stoich. When that stoich falls below the minimum value needed to support the stack current, one or both electrodes in a cell may be driven into potential ranges where parasitic electrode reactions arise to make up the deficit in current. Parasitic reactions caused by low stoich conditions can arise during both charge and discharge operations. All of the charge consumed in these parasitic reactions subtracts directly from the useable charge stored by the battery and hence lowers the round trip energy efficiency.

An RFB can achieve a round trip energy efficiency (the ratio of output energy to input energy) that competes favorably with other electrical energy storage technologies but approaching that high efficiency can be costly. As observed by Nguyen and Savinell, in Flow Batteries, Interface, Fall 2010, pp. 54-56, satisfying the competing demands of cost and efficiency is the primary obstacle to the commercialization of RFBs.

### Modular Cell Arrangements

In embodiments, systems and methods disclosed herein may improve the round-trip energy storage efficiency of an RFB by reducing losses in both the Voltage efficiency and the Faradaic efficiency of the battery. In some cases, a high Faradaic efficiency may be achieved by cell arrangements that maintain stoich values throughout the battery at or above the levels needed in each cell to hold parasitic reactions to a minimum. A high Voltage efficiency may be achieved by cell arrangements that diminish voltage losses due to shunt currents.

In various embodiments, several advantages are provided by configuring an RFB cell stack by connecting a plurality of modular blocks of cells (also referred to herein as cell modules). Each cell module may include any number of cells, and an RFB stack (and/or a cascade stage) may be assembled by fluidically and electrically connecting a plurality of modular cell blocks in a desired configuration. In embodiments, cell modules in a given stack or a given cascade stage may all have an equal number of cells. In other embodiments, an RFB stack or a cascade RFB stage may be assembled using a plurality of modules, some of which having a different number of cells than others. Within a single cell module, cells may typically be electrically connected to one another in series in a bipolar stack configuration, while electrolytes flow in parallel through all cells of a module. Cell modules may generally be fluidically connected to one another in parallel, while electrical connections between modules may be configured to be switchable between series and parallel connections. Various advantageous arrangements of such cell modules will be apparent in view of the discussion and examples herein.

According to embodiments of the systems and methods herein, cell modules may be arranged in ways that raise output power while avoiding the costs normally associated with increasing the physical size of RFB cells. Additionally, in embodiments, cells within an RFB may be grouped into modules that may be arranged in ways that allow the RFB to operate over a wide range of SOC while maintaining high round trip energy efficiency.

### Modular Cell Blocks—“Virtual Cells”

While the energy storage capacity of an RFB is limited only by the volume of the external storage components, the power produced by an RFB is determined by the size of the battery stack. The power output of a battery is the product of the current and voltage that it delivers (Watts=Volts×Amps). For a given battery chemistry, the current output depends on the electrode area of the individual battery cells.

In the past, manufacturability and other considerations have imposed finite limits on the physical dimensions of a cell. As a result, there is an upper limit to the electric current that can be delivered by some RFB configurations.

However, two RFB cells electrically connected in parallel produce the same electrical output as one cell of twice the area. Therefore, larger cells may be created by electrically connecting smaller cells in parallel. In some cases, this may be achieved by connecting two or more modular cell blocks in parallel. Two cells that occupy corresponding positions within parallel blocks then behave as a single “virtual cell” of twice the area. Hence, modular cell blocks can provide a convenient way of increasing effective cell dimensions while also providing additional operating and efficiency benefits in an RFB system.

The concept of virtual cells may be further clarified with reference to FIG. 5, which illustrates an arrangement of the three RFB cell block modules 49 that are electrically 37 and fluidically 39 connected in parallel. Assuming each module 49 contains six cells, the parallel combination shown can be viewed as a single block of six “virtual cells”, each virtual cell possessing an area three times the area of the individual modular cells. Connecting a group of such virtual cells in electrical series with a second group produces the same result as a series-connected string of cells three times the size of the modular cells. In this way, a stack capable of handling any desired voltage and current may be produced by connecting cell modules in parallel and connecting such parallel groups in series.

In some embodiments, a single mechanical stack of cells may be divided into two or more cell modules by interposing an electrically insulating layer between two cells at a desired dividing point. In various embodiments, such an insulating layer may also include a conduit for allowing electrolyte to flow to cells on both sides of the insulating layer.

### Modular Cell Blocks—Cells Per Stage

One way to counteract losses in Faradaic efficiency arising from low stoich conditions is to raise the flow rate of the electrolytes in affected cells. According to embodiments of the systems and methods disclosed herein, the required increase in electrolyte flow rate may be achieved by reducing the cell count within affected stages of the cascade.

For example, if the flow rate through the cascade is 20 L/min with 20 cells per stage, then reducing the cell count in a stage to 10 cells of equal size will raise the flow rate per cell from 1 L/min to 2 L/min. Assuming all other conditions remain constant, the net result would be to double both the flux of reactant species and the stoich in each cell. The increased stoich may allow the battery to operate over a wider range of SOC and/or to achieve greater round trip energy storage efficiency.

Hence, in embodiments, cell count per cascade stage may be adjusted to optimize aspects of system performance. For example, since low stoich conditions tend to develop at the low SOC end of the cascade on discharge and at the high SOC end on charge, improved system performance may be achieved by employing reduced numbers of cells in the stages at both ends of the cascade. In embodiments, cell count in each stage may be varied by assembling each stage with a varying number of cell modules. Cell modules may have the same or different numbers of cells to achieve the desired cell count in each stage.

A smaller number of cells at the high SOC end during discharge will not degrade Faradaic efficiency but it will reduce the voltage output of the stage, hence reducing “shunt current” losses in that stage. In an RFB, a shunt current is an ionic current that flows in the electrolyte between the anode of one cell and the cathode of another cell in the stack, bypassing one or more cells en route. Because shunt currents do not flow in series through all of the cells, they represent a short-circuit path that diminishes Voltage efficiency and hence system efficiency. The energy losses are proportional to the voltage drop across the bypassed cells; hence shunt voltage losses are less significant in lower SOC stages of a cascade stack.

### Modular Cell Blocks—Current Per Cell

Another way to counteract losses in Faradaic efficiency arising from low stoich conditions is to alter electrical connections within a stack or a stage to achieve an electric current in each cell that maintains stoich within a desired range based on a range of electrolyte flux. As described above, it may be desirable to maintain stoich, (the ratio of reactant flux to the rate of reactant consumption), above unity (1.0). In other words, it may be desirable or necessary under some conditions to maintain a rate of reactant consumption that is less than the rate at which reactants are supplied into the cell. The rate of reactant consumption may be increased or decreased by increasing or decreasing the electric current supplied to the cell (during charging) or drawn from the cell (during discharging).

In embodiments, an RFB comprising a plurality of modular blocks may be configured to compensate for low stoich conditions by adjusting the electric current flowing in low-stoich cells. In embodiments, such adjustments to electric current may take the form of a fixed relationship achieved by assembling a cascade stack with a predetermined combination of cell modules connected to one another with fixed series or parallel connections. In other embodiments, adjustments to electric current may be made dynamically by providing switches or relays between cell modules, thereby allowing for dynamic changes to the series vs. parallel connections of the modules.

Such adjustments are not possible within a single cell block in which all cells are electrically connected in series. For example, if a cell block generates an output voltage of 100V and the discharge resistance (including the load) is 1 ohm, then, by Ohm's law, the current flowing in the block (and hence the current per cell) is fixed at 100 Amps. However, in embodiments, adjustments to electrical current per cell may be made when a stage (or stack) is made up of a plurality of modular cell blocks by electrically connecting two or more blocks in parallel with one another.

Within each bipolar stack cell module, the cells may be connected electrically in series, but the current flowing in the individual cells may be decreased by connecting multiple modules in parallel. Compared with the above example, distributing the same 100 Amp current among four parallel modules would lower the current in each cell module (and thus in each cell) to 25 Amps. The change would also lower the output voltage of the stage to one fourth of what it would be if all four modules were electrically connected in series.

In embodiments, modular cell blocks may be arranged with static electric and fluidic connections according to a configuration that maintains a stoich above some minimum desired value during both charge and discharge. In other embodiments, modular cell blocks may be arranged with dynamic electric and/or fluidic connections in order to allow for the selection of different configurations during charge and discharge or during other operating conditions.

In embodiments, cell block modules may be configured with different numbers of cells, such that a single cascade RFB stack may include some modules that contain more cells than other modules. FIG. 6 illustrates an embodiment of a five-stage cascade RFB stack made up of modules with varying numbers of cells, based on requirements of a particular RFB system. Each cascade stage 41-45 in the stack 14 of FIG. 6 is shown with a total of 36 cells in multiple modules. As shown, the cells within each module are electrically connected in series (in a bipolar stack configuration), and modules within a single stage may be electrically connected to one another in parallel. The stages 41-45 may be electrically connected to one another in series.

FIG. 6 illustrates one possible static arrangement of cell modules for a cascade RFB (e.g., such as the cascade RFB shown in FIG. 4). For the purposes of explanation, the cascade stack in the illustrated embodiment may include five stages, of which (from left to right): each of the first stage 41 and the second stage 42 may have two modules 51 of 18 cells each; the third stage 43 may have three modules 53 of 12 cells each; the fourth stage 44 may have four modules 54 of nine cells each; and the fifth stage 45 may have six modules 55 of six cells each. In the cascade of FIG. 6, the cell blocks of each stage may be fluidically connected in parallel so that electrolytes flow through all cells of a common stage simultaneously before entering the cells of the next stage. In such an arrangement, every cell within all modules of a given cascade stage may be exposed to electrolytes of the same SOC as every other cell within the same stage. The cell blocks may be electrically connected as shown (i.e., blocks of a common stage in parallel, and stages in series).

For purposes of illustration, the starting SOC may be taken as 100%, the final SOC may be taken as 10%, and the SOC change in the first stage may be taken as 10%. Using these values and assuming a discharging operation occurs as electrolytes pass from left-to-right through the cascade stack of FIG. 6, calculated values for the mean electrolyte SOC and the relative current per cell are listed in Table 1. Since SOC change per stage is proportional to current per cell, the approximate SOC change in subsequent stages may be calculated relative to the first stage and the calculated relative current per cell. For simplicity of comparison the relative current per cell and relative stoich are calculated relative to that in the first stage 41 (i.e., assuming the value in the first stage to be 1.0). FIG. 7 is a graph of relative current per cell vs. mean SOC in each stage according to this example. These values represent simplified conditions for the purpose of explanation and do not necessarily account for losses or other variations.

Table 1 contains values of the mean SOC, relative current per cell and relative stoich per cell calculated during discharge of the modular 5-stage cascade RFB of FIG. 6.

TABLE 1

| | SOC | Mean | Parallel | Cells/ | Relative | Relative |
|---|---|---|---|---|---|---|
| Stage # | Change | SOC | Modules | Module | Current/Cell | Stoich/Cell |
| 41 | 25% | 88% | 2 | 18 | 1.00 | 1.00 |
| 42 | 25% | 63% | 2 | 18 | 1.00 | 0.71 |
| 43 | 17% | 42% | 3 | 12 | 0.67 | 0.71 |
| 44 | 13% | 27% | 4 | 9 | 0.50 | 0.62 |
| 45 | 8% | 17% | 6 | 6 | 0.33 | 0.57 |

Assuming that the electrolyte flux within the cells of a given stage is directly proportional to the mean SOC in that stage, an approximation of relative stoich per cell may be calculated by dividing the mean SOC in a stage by the relative current per cell. The “Relative Stoich/Cell” column of Table 1 represents relative stoich per cell as a percent of the relative stoich in the cells of the first stage 41. The graph of FIG. 7 suggests that the modular cell block configuration of FIG. 6 described above may maintain stoich in the final stage 45 (at the lowest SOC during discharge) only about 43% below the stoich in the first stage. Thus, in embodiments it may be desirable to configure a modular cascade so as to prevent stoich from falling below a threshold value while balancing other factors.

The same example values may be used to illustrate a charging scenario as electrolytes flow from right-to-left through the same 5-stage cascade RFB of FIG. 6. In such an example, most of the values in table 1 may be the same, but reversed as electrolytes flow from right to left, with decreasing SOC in each stage. Approximate relative stoich per cell during charging may be calculated using the inverse of mean SOC in each stage. In actual practice, the values for charging and discharging will be slightly different, since parasitic reactions and other inefficiencies may occur more readily during one cycle than the other. Additionally, relative values will tend to vary from those in the simplified example above due to various inefficiencies and other complexities. For example, the voltage of the cells in each stage will tend to vary because of differences in open-circuit voltage (OCV) at different SOC values, and some efficiency losses change according to SOC and current density.

In embodiments, a modular cascade arrangement may be made up of equal cell-count modules connected in various series/parallel combinations to produce a cascade with varying number of parallel-connected modules per stage. In embodiments, all cell block modules used in an RFB stack may have the same number of cells. In embodiments, multiple modules may be electrically connected in series to simulate cell blocks with larger numbers of cells. FIG. 8 illustrates an example of such a system. In the 5-stage cascade stack 14 of FIG. 8, each stage 41-45 may be made up of 18 modular blocks 49, each of which may contain four cells for a total of 72 cells per stage. The cells within each block 49 may be arranged in a bipolar stack configuration and may therefore be electrically connected in series. For simplicity of explanation, this cascade of example (and others herein) may have an equal number of cells in all stages. However, this is not necessary in all embodiments. In some cases, as described in some examples above, it may be beneficial to vary the number of cells per stage.

A faradic efficiency improvement similar to that described above with reference to FIG. 6 may be achieved by connecting groups of modular cell blocks in series to form a larger effective block, connecting two or more series-connected groups (also referred to as effective blocks) in parallel and connecting respective cascade stages in series.

As shown in FIG. 8, the first stage 41 may include two groups of 9 series-connected modules, and each group of modules may form an effective block 57. The two groups of series-connected modules 49 may be connected in parallel with one another. The first stage 41 may be connected in series with the second stage 42 which in the illustrated example may be configured identically with the first stage 41. The third stage 43 may include three groups of series-connected modules 49, and the three groups may be connected in parallel with one another. The fourth stage 44 and the fifth stage 45 may include nine parallel-connected groups, each group having two series-connected modules 49. All of the stages 41-45 may be electrically connected in series. The modular blocks 49 of each stage may be fluidically connected in parallel such that electrolytes flow through all cells of a common stage simultaneously before flowing into the cell blocks of the next downstream cascade stage.

As an example, values while discharging the cascade RFB of FIG. 8 may be calculated using the following parameters: the starting SOC may be taken as 100%, the final SOC may be taken as 5%, and the SOC change in the first stage may be taken as 10%. Using these values, the calculated results are shown below in Table 2.

Table 2 contains values of the mean SOC, relative current/cell, and relative stoich per cell calculated during the discharging of the modular 5-stage cascade RFB of FIG. 8.

TABLE 2

| | | | | Cells/ | # of | Relative | Relative |
|---|---|---|---|---|---|---|---|
| Stage | Mean | SOC | Parallel | Parallel | Parallel | Current/ | Stoich/ |
| # | SOC | Change | Modules | Group | Groups | Cell | Cell |
| 41 | 88% | 25 | 9 | 36 | 2 | 1 | 1.0 |
| 42 | 67% | 17 | 6 | 24 | 3 | 0.67 | 1.14 |
| 43 | 50% | 17 | 6 | 24 | 3 | 0.67 | 0.86 |
| 44 | 33% | 17 | 6 | 24 | 3 | 0.67 | 0.57 |
| 45 | 21% | 8 | 3 | 12 | 6 | 0.33 | 0.71 |

Assuming that the electrolyte flux within the cells of a given stage is directly proportional to the mean SOC in that stage, an approximation of relative stoich per cell may be calculated by dividing the mean SOC in a stage by the relative current per cell. The “Relative Stoich/Cell” column of Table 2 represents relative stoich per cell as a percent of the relative stoich in the cells of the first stage 41. As shown in the graph of FIG. 9, despite a 5-fold change in SOC across the cascade, the modular cell block configuration of FIG. 8 described above may maintain stoich within about 40% across the cascade. Thus, in embodiments it may be desirable to configure a modular cascade by connecting at least one cell module in parallel with other cell modules within a cascade stage so as to prevent stoich from falling below a threshold value in one or more targeted stages while balancing other factors.

The same example may be used to illustrate a charging scenario as electrolytes flow from right-to-left through the same 5-stage cascade RFB of FIG. 8. In such an example, most of the values in Table 2 may be the same, but reversed as electrolytes flow from right to left, with increasing SOC in each stage. Approximate relative stoich per cell during charging may be calculated using the inverse of mean SOC to represent flux of reactants available for charging. In actual practice, the values for charging and discharging will be slightly different, since parasitic reactions and other inefficiencies may occur more readily during one cycle than the other. Additionally, relative values will tend to vary from those in the simplified examples here due to various inefficiencies and other complexities. For example, the voltage of the cells in each stage will tend to vary because of differences in open-circuit voltage (OCV) at different SOC values, and some efficiency losses vary according to SOC and current density.

Some of the above examples are based on a goal of maintaining stoich above some minimum threshold by controlling electric current per cell. As shown by examples above, such an objective may generally be met by configuring a progression of parallel-connected blocks per stage such that a minimum stoich value remains above a desired threshold.

However, the goal of maintaining stoich above a threshold may not always be the best starting point. Another advantage of some modular cascade configurations is that round trip efficiency may be substantially increased by substantially increasing electric current in stages with electrolytes at high states of charge (during both charge and discharge) without particular concern for operating at low stoich conditions. This increased current in one or more high SOC stages tends to decrease parasitic reactions (such as H₂ generation in some cases) which may tend to increase at higher states of charge in some flow battery systems. It has been discovered that parasitic hydrogen generation may increase as a second degree polynomial function of SOC in some cases.

Counter-intuitively, a flow battery arrangement in which the one or more highest SOC stages experience electric currents per cell substantially higher than current per cell in lower SOC stages may experience substantially reduced rates of parasitic reactions. This may result from the fact that the higher current in the high SOC stage(s) may tend to accelerate charging and discharging in that stage. Therefore, a cascade stage configured to produce a non-linear monotonic progression of electrolyte SOC may be advantageous. In some cases a cascade stage configured to produce a non-linear monotonic progression of electrolyte SOC with a single high SOC stage configured to receive a higher electric current (e.g., by having a smaller number of modules in electric parallel than other cascade stages) may be particularly advantageous. Table 3 provides an example of a six-stage cascade with 120 cells per stage arranged into multiple modules.

Table 3 contains values of the mean SOC, relative current/cell, and relative stoich per cell calculated during the charging of a modular 6-stage cascade RFB configured to produce a non-linear monotonic progression of SOC.

TABLE 3

| | Mean | SOC | Parallel | Cells per | Relative | Relative |
|---|---|---|---|---|---|---|
| Stage # | SOC | Change | Modules | Module | Current/Cell | Stoich/Cell |
| 1 | 15% | 11% | 6 | 20 | 1.0 | 1.00 |
| 2 | 26% | 11% | 6 | 20 | 1.0 | 0.87 |
| 3 | 38% | 13% | 5 | 24 | 1.2 | 0.61 |
| 4 | 53% | 17% | 4 | 30 | 1.5 | 0.37 |
| 5 | 70% | 17% | 4 | 30 | 1.5 | 0.24 |
| 6 | 89% | 22% | 3 | 40 | 2.0 | 0.06 |

Thus, in embodiments, a cascade flow battery arrangement may be configured with a highest SOC stage (i.e., stage 6 in the example of Table 3) configured to experience an electric current per cell that is significantly higher than the electric current per cell in the lowest SOC stage (i.e., stage 1 in the example of Table 3), while the current in each stage is equal. As described above, this may be achieved by connecting a greater number of modules in parallel in the highest SOC stage than in the lowest SOC stage. In various embodiments, the current per cell of the high SOC stage may be at least measurably greater than the current per cell in the low SOC stage. In some particular embodiments, the current per cell of the high SOC stage may be at least 1.5 times, 2 times, 2.5 times, 3 times or more greater than the current per cell in the low SOC stage. Also, as described in various examples herein, stages in a cascade may be arranged with a number of parallel-connected modules per stage that varies as a non-linear monotonic progression.

As will be clear in view of the above, the size of the SOC change in a given stage may be a function of electric current in the cells of the stage. Similarly, increasing the number of parallel-connected blocks in a stage will decrease current per cell relative to a stage with fewer parallel-connected blocks (assuming an equal current is applied to each stage). Therefore, similar objectives may be achieved by arranging any of the following variables in a non-linear monotonic progression: current per cell per stage, the SOC change per stage, the mean SOC per stage, the inlet SOC in each stage or the outlet SOC in each stage. In some cases, configuring one of these variables with a non-linear monotonic progression may not necessarily lead to an identical progression in all of the other variables due to various inefficiencies and complexities as will be clear to the skilled artisan in view of the disclosure herein.

### Switchable Electrical Series/Parallel Connections

In various embodiments, a group of cell modules may be switchable between parallel and series electrical connections. The schematic diagrams of FIG. 10A-FIG. 10E illustrate an example of a modular RFB system with six cell modules 49 with switchable electrical connections 92 between cell modules 49. A system 80 such as that shown in FIG. 10A may be used as all or a portion of a single stage of a cascade RFB stack or as all or a portion of a recirculating RFB stack. Such a system may be used or in place of any of the examples of fixed-relationship cascade RFB systems described above or any other configuration.

In some cases, electrical connections 92 between the modules 49 may be selected by switching electrical relays 92 (or any other switching circuits or devices). The relays 92 may be switchable between an open circuit position (as shown by the position of all relays in FIG. 10A), a “series” position 94 (as shown by the position of all relays in FIG. 10B), and a “parallel” position 96 (as shown by the position of all relays in FIG. 10E). In various embodiments, the principles illustrated in FIG. 10A may be applied to any number of switchable cell modules, each of which may have any number of cells as needed for a particular application. For example, in embodiments, a single switchable cell module may be connected to one or more cell modules. As illustrated in FIG. 10A-10E, the switch elements may be coupled through a control bus 19a to a controller, such as controller 19, which may be used to configure any or all of the switches either individually or as a group.

In embodiments, the relays 92 may be operated by an electronic controller 19 which may be programmed as needed to create various series and parallel connections. In embodiments, the controller 19 may be configured to apply different electrical connection configurations during charge and discharge, hence compensating for progressive changes in SOC for each operation without the need to reverse the direction of electrolyte flow.

In other embodiments, the controller 19 may be configured to apply different electrical connection configurations in response to other controlled or sensed operating conditions. For example, the controller 19 may be used to prevent damage to the system from hardware defects such as an electrical short circuit by placing the affected module (or modules) at open circuit or by reducing current through the effected module(s) by switching to a parallel relationship with one or more other modules.

In another example, some electronic components (such as inverters and/or power supplies) may have a minimum operating voltage that is higher than can be produced by some discharged cascade RFB systems. Thus, under such conditions, it may be desirable to temporarily switch all cells of all modular blocks to series connections in order to temporarily increase the voltage produced by the complete RFB stack.

### Embodiments of Modular Stack Arrangements in Recirculating RFB Systems

Some advantages of modular cell configurations are also applicable to non-cascade RFBs. For example, the modular stack 80 of FIG. 10A may be configured as a recirculating RFB in which electrolytes are circulated through the cells of the 6 modules multiple times (with electrolytes flowing in parallel through all six modules at the same time). For the purposes of this example, each module may have 6 cells in series. Connections between the modules 49 may be selected at will via remotely-controlled electrical relays. The relays may be programmed as needed to create various series and parallel connections, allowing the RFB to respond efficiently to progressive changes in electrolyte SOC during each electrolyte cycle or in response to other conditions as described above.

FIGS. 10A-10E illustrate various possible electrical connection arrangements for a switchable modular recirculating RFB stack. Four different electrical series/parallel combinations of cell modules are shown in FIGS. 10B-10E. Connecting all 6 modules in series (FIG. 10B) may create a stack with 36 cells in series 82. Switching the center relay from series to a parallel connection 96 as shown in FIG. 10C may create a stack 84 with two parallel strings, each having 18 cells in series. As shown in FIG. 10D, connecting the modules as three parallel groups of series-connected modules may create a stack 86 with three parallel strings, each having 12 cells in series. Similarly, connecting all six modules in parallel may create a stack with 6 parallel strings, each having 6 cells in series 88.

With reference to the four configurations of FIG. 10B-10E, the advantages of a switchable modular recirculating stack arrangement may be seen during a discharge case. For purposes of illustration, the initial SOC may be taken as 100%, the final SOC may be taken as 10%, and the SOC change during the first pass through the stack (or cycle) may be taken as 18%. After each pass, the modular connections may be adjusted to better accommodate the reduced SOC during the next pass. Table 4 shows calculated values for the mean electrolyte SOC and the relative current per cell during five electrolyte passes through the cell stack. In this example, the modules may be reconfigured by changing electrical connections after the first, second and fourth pass.

Table 4 contains values of the mean SOC and relative current/cell calculated during discharge for various configurations of the switchable modular stack of FIG. 10A.

TABLE 4

| | | | | | Series | Relative | Relative |
|---|---|---|---|---|---|---|---|
| Pass | | Mean | SOC | Parallel | Cells/ | Current/ | Stoich/ |
| # | FIG. # | SOC | Change | Modules | Module | Cell | Cell |
| 1 | 10C | 67% | 25% | 2 | 18 | 1.00 | 1.00 |
| 2 | 10C | 50% | 25% | 2 | 18 | 1.00 | 0.75 |
| 3 | 10D | 33% | 17% | 3 | 12 | 0.67 | 0.75 |
| 4 | 10D | 22% | 17% | 3 | 12 | 0.67 | 0.5 |
| 5 | 10E | 11% | 8% | 6 | 6 | 0.33 | 0.5 |

FIG. 11 is a graph showing relative current per cell, mean SOC, and relative stoich in each pass during discharging according to the example. Assuming that the electrolyte flux within the cells during a given pass is directly proportional to the mean SOC in that stage an approximation of relative stoich per cell may be calculated by dividing the mean SOC in a stage by the relative current per cell. The “Relative Stoich/Cell” column of Table 4 represents relative stoich per cell as a percent of the relative stoich in the cells during the first pass. As shown in the graph of FIG. 11, the switched modular cell block configuration of this example may maintain stoich within about 50% across all cycles. Thus, in embodiments it may be desirable to configure a modular cascade by connecting at least one cell module in parallel with other cell modules within a cascade stage so as to prevent stoich from falling below a threshold value in one or more targeted stages while balancing other factors.

The same example may be used to illustrate a charging scenario. In such an example, most of the values in Table 2 may be the same, but reversed as the configurations are switched to address charging from low SOC to high SOC with SOC increasing in each pass. Approximate relative stoich per cell during charging may be calculated using the inverse of mean SOC to represent flux of reactants available for charging. In actual practice, the values for charging and discharging will be slightly different, since parasitic reactions and other inefficiencies may occur more readily during one cycle than the other. Additionally, relative values will tend to vary from those in the simplified examples here due to various inefficiencies and other complexities. For example, the voltage of the cells in each stage will tend to vary because of differences in open-circuit voltage (OCV) at different SOC values, and some efficiency losses vary according to SOC and current density.

In embodiments, a configuration of a switchable recirculating stack (or cascade stage) may be changed during charging relative to a configuration used during discharging in order to adjust for a variation in voltage between charge and discharge reactions.

Thus, by using an RFB stack made up of a plurality of switchable modular cell blocks, the variation in stoich during each operating cycle of a recirculating RFB may be reduced, thereby improving Faradic efficiency of such a system. In various alternative embodiments, the number of modules per stack and the number of cells per module may be varied as needed for a particular application. In still further embodiments, it may be desirable to leave one or more modules electrically “switched off” by leaving the relays connecting that module in an open circuit condition (as shown in FIG. 10A). In this way, the power produced or drawn by the stack may be further varied without the need for altering fluid flows (such as by operating valves). Such switched-off modules may be used in recirculating or cascade RFB systems.

In other cases, a controller 19 may be configured to switch parallel/series relationships between modules in response to a state-of-charge of electrolytes detected or assumed during one or more cycles with a recirculating RFB system. For example, it is well understood that the voltage produced or consumed by a recirculating flow battery stack will tend to vary depending on the SOC of electrolytes during a given cycle. In order to maintain voltage input to the stack during charging or output from the stack during discharging, a controller 19 may switch one or more modules between parallel and series connections with the rest of a stack. The number of cells in the modules to be switched may be configured to maintain overall stack voltage within a predetermined range.

Some of the examples of cascade flow battery stacks described above include cascades configured for bi-directional flow of electrolytes in which electrolytes flow in one direction through the cascade during charging, and in the opposite direction during discharging. Many of the benefits of the configurations described herein may also be applied to cascade flow battery stacks configured for uni-directional flow in which electrolytes flow in one direction through the cascade during both charging and discharging. Many of the benefits of the configurations described herein may also be applied to cascade flow battery stacks configured for either charging or discharging alone.

Although many of the embodiments herein are described with reference to Fe/Cr RFB chemistry, it should be appreciated with the benefit of the present disclosure that embodiments are applicable to RFB systems (and some hybrid flow battery systems) using other reactants. In addition to the Fe/Cr RFB chemistry, the various embodiments above may be adapted for use with many other RFB chemistries using at least one flowing liquid electrolyte. For example, some known alternative flow battery chemistries include: all vanadium (V/V), iron-vanadium (Fe/V), hydrogen bromine (HBr), tin-iron (Sn/Fe), vanadium cerium (V/Ce), vanadium-polyhalide (V/Br2), iron-bromine (Fe/Br2), titanium-iron (Ti/Fe), iron-ethylenediaminetetraacetic acid-bromine (Fe-EDTA/Br), zinc-cerium (Zn/Ce), zinc-bromine (Zn/Br), and bromine polysulfide (S/Br2).

Although many of the embodiments herein are described with reference to cascade flow RFB architecture, it should be appreciated with the benefit of the present disclosure that embodiments are applicable to RFBs (and some hybrid flow battery systems) of other architectures, including recirculating systems such as that shown in FIG. 1.

The foregoing description of the various embodiments is provided to enable any person skilled in the art to make or use the systems and methods herein. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, and instead the claims should be accorded the widest scope consistent with the principles and novel features disclosed herein.

1. A redox flow battery system comprising:
a plurality of cascade stages, each of the plurality of cascade stages comprising a plurality of cells arranged into at least one bipolar cell module, the plurality of cascade stages being electrically connected in series with one another; and
a source of redox electrolyte coupled to the plurality of cascade stages,
wherein:
the plurality of cascade stages are coupled in fluidic series so as to direct the redox electrolyte through all of the plurality of cascade stages from a first cascade stage of the plurality of cascade stages positioned at a high state-of-charge end of the plurality of cascade stages to a last cascade stage of the plurality of cascade stages positioned at a low state-of-charge end of the plurality of cascade stages; and
an electric current in each of the plurality of cells of the first cascade stage is at least twice as great as an electric current in each cell of the last cascade stage.

2. The redox flow battery system of claim 1, wherein the last cascade stage comprises at least two bipolar cell modules joined in electric parallel with one another.

3. The redox flow battery system of claim 2, wherein the last cascade stage has a greater number of bipolar cell modules joined in electric parallel than the first cascade stage.

4. The redox flow battery system of claim 3, wherein respective electric current in each of the plurality of cascade stages decreases according to a non-linear monotonic progression from a first electric current of the first cascade stage to a last electric current of the last cascade stage.

5. The redox flow battery system of claim 1, wherein a respective number of bipolar cell modules in each of the plurality of cascade stages decreases according to a non-linear monotonic progression from a last number of bipolar cell modules in the last cascade stage to a first number of bipolar cell modules in the first cascade stage.

6. The redox flow battery system of claim 1, wherein a respective mean state-of-charge of the electrolyte in each of the plurality of cascade stages decreases according to a non-linear monotonic progression from a first mean state-of-charge of the first cascade stage to a last mean state-of-charge of the last cascade stage.

7. The redox flow battery system of claim 1, wherein a respective state-of-charge change in each of the plurality of cascade stages decreases according to a non-linear monotonic progression from a first state-of-charge change of the first cascade stage to a last state-of-charge change of the last cascade stage.

8. The redox flow battery system of claim 1, wherein at least one of the plurality of cascade stages comprises at least a first bipolar cell module connected to at least a second bipolar cell module via a switch, wherein the switch has a first switch configuration that connects the first bipolar cell module and the second bipolar cell module in series with one another and a second switch configuration that connects the first bipolar cell module and the second bipolar cell module in parallel with one another.

9. The redox flow battery system of claim 8, further comprising a controller coupled to the switch, the controller configured to control the switch between the first switch configuration and the second switch configuration.

10. The redox flow battery system of claim 9, wherein the controller is configured to control the switch from the first switch configuration to the second switch configuration based on a fault condition.

11. The redox flow battery system of claim 1, wherein each of the plurality of cascade stages comprises an equal number of the plurality of cell modules.

12. The redox flow battery system of claim 1, wherein at least one of the plurality of cascade stages comprises a different total number of the plurality of cell modules than at least a second one of the plurality of cascade stages.

13. The redox flow battery system of claim 1, wherein at least one of the plurality of cascade stages comprises at least two bipolar cell modules connected to one another in series.

14. The redox flow battery system of claim 1, wherein each of the plurality of cascade stages comprises an equal number of cells.

15. A method of charging a recirculating redox flow battery, the method comprising:
pumping liquid electrolytes into a reaction stack assembly for a first cycle, the reaction stack assembly comprising a plurality of cell modules connected to one another with electrical connections remotely switchable between a parallel connection and a series connection, the plurality of cell modules being fluidically connected in parallel with a source of the liquid electrolytes;
remotely switching the electrical connections between a first at least two of the plurality of cell modules from a series connection to parallel connection; and
pumping the liquid electrolytes into a stack assembly for a second cycle.

16. The method of claim 15, wherein the first cycle and the second cycle comprise a charge cycle.

17. The method of claim 15, wherein the first cycle comprises a charge cycle and the second cycle comprises a discharge cycle.

18. The method of claim 15, wherein the remotely switching the electrical connections further comprises remotely switching the electrical connection between the first at least two of the plurality of cell modules to a parallel connection during the first cycle.

19. The method of claim 18, wherein the remotely switching the electrical connections further comprises remotely switching the electrical connection between a second at least two of the plurality of cell modules to a parallel connection during the second cycle, the first at least two of the plurality of cell modules different from the second at least two of the plurality of cell modules.

20. The method of claim 15, wherein the reaction stack assembly comprises a cascade of stages arranged in fluidic series with one another, each stage of the cascade of stages having a configuration that changes a state-of-charge of the liquid electrolytes by a discrete amount.

21. The method of claim 15, wherein the reaction stack assembly comprises a recirculating stack having a configuration that changes a state-of-charge of the electrolytes in multiple cycles.

22. A redox flow battery system comprising:
a plurality of cascade stages, each of the plurality of cascade stages comprising a plurality of cells arranged into at least one bipolar cell module, the plurality of cascade stages being electrically connected in series with one another; and
a source of redox electrolyte coupled to the plurality of cascade stages,
wherein:
the plurality of cascade stages are coupled in fluidic series so as to direct the redox electrolyte through all of the plurality of cascade stages from a first cascade stage of the plurality of cascade stages positioned at a high state-of-charge end of the plurality of cascade stages to a last cascade stage of the plurality of cascade stages positioned at a low state-of-charge end of the plurality of cascade stages; and
a respective mean state-of-charge of the redox electrolyte in each cascade stage of the plurality of cascade stages decreases according to a non-linear monotonic progression from a first mean state-of-charge of the redox electrolyte in the first cascade stage to a last mean state-of-charge of the redox electrolyte in the last cascade stage.

23. The redox flow battery system of claim 22, wherein the last cascade stage comprises at least two bipolar cell modules joined in electric parallel with one another.

24. The redox flow battery system of claim 23, wherein the last cascade stage has a greater number of bipolar cell modules joined in electric parallel than the first cascade stage.

25. The redox flow battery system of claim 24, wherein a respective electric current in each of the plurality of cascade stages increases according to a non-linear monotonic progression from a last electric current in the last cascade stage to a first electric current in the first cascade stage.

26. The redox flow battery system of claim 22, wherein a respective number of bipolar cell modules in each of the plurality of cascade stages decreases according to a non-linear monotonic progression from a last number of bipolar cell modules in the last cascade stage to a first number of bipolar cell modules in the first cascade stage.

27. The redox flow battery system of claim 22, wherein a respective state-of-charge change in each of the plurality of cascade stages decreases according to a non-linear monotonic progression from a first state-of-charge change in the first cascade stage to a last state-of-charge change in the last cascade stage.

28. The redox flow battery system of claim 22, wherein at least one of the plurality of cascade stages comprises at least a first bipolar cell module connected to at least a second bipolar cell module via a switch, wherein the switch has a first switch configuration that connects the first bipolar cell module and the second bipolar cell module in series with one another and a second switch configuration that connects the first bipolar cell module and the second bipolar cell module in parallel with one another.

29. The redox flow battery system of claim 28, further comprising a controller coupled to the switch, the controller configured to control the switch between the first switch configuration and the second switch configuration.

30. The redox flow battery system of claim 29, wherein the controller is configured to control the switch from the first switch configuration to the second switch configuration based on a fault condition.

31. The redox flow battery system of claim 22, wherein each of the plurality of cascade stages comprises an equal number of cells.

32. The redox flow battery system of claim 22, wherein at least one of the plurality of cascade stages comprises a different total number of cells than at least a second one of the plurality of cascade stages.

33. The redox flow battery system of claim 22, wherein at least one of the plurality of cascade stages comprises at least two bipolar cell modules connected to one another in series.
